(19) United States
(12) Patent Application Publication
(10) Pub. No.: US 2025/0247199 A1
(43) Pub. Date: Jul. 31, 2025

(54) TECHNIQUES FOR ENABLING USER EQUIPMENT SENSING IN DOWNLINK SLOTS

(71) Applicant: QUALCOMM Incorporated, San Diego, CA (US)

(72) Inventors: Shijun WU, San Diego, CA (US); Kapil GULATI, Belle Mead, NJ (US); Stelios STEFANATOS, San Diego, CA (US); Preeti KUMARI, San Diego, CA (US)

(21) Appl. No.: 18/424,429

(22) Filed: Jan. 26, 2024

(51) Int. Cl. H04L 5/14; H04B 7/06; H04L 1/00; H04L 5/00; H04W 8/22

(52) U.S. Cl. CPC H04L 5/1469; H04B 7/0626; H04L 1/0067; H04L 5/0051; H04W 8/22

(57) ABSTRACT

Aspects described herein relate to receiving, from a network entity, a time division duplexing (TDD) format configuration indicating at least a portion of multiple time divisions as being configured for downlink data communications from the network entity, and transmitting or receiving, in a subset of at least the portion of the multiple time divisions, a signal to enable sensing the UE by one or more other UEs.

### FIELD OF THE DISCLOSURE

Aspects of the present disclosure relate generally to wireless communication systems, and more particularly, to communicating user equipment (UE) sensing signals.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, a method for wireless communications at a user equipment (UE) is provided that includes receiving, from a network entity, a time division duplexing (TDD) format configuration indicating at least a portion of multiple time divisions as being configured for downlink data communications from the network entity, and transmitting, in a subset of at least the portion of the multiple time divisions, a signal to enable sensing by the UE.

In another aspect, a method for wireless communications at a UE is provided that includes receiving, from a network entity, a TDD format configuration indicating at least a portion of multiple time divisions as being configured for downlink data communications from the network entity, and receiving, from the network entity and in a subset of at least the portion of the multiple time divisions, a downlink signal that overlaps resources with a signal transmitted by a second UE to enable sensing by the second UE.

In another aspect, a method for wireless communications at a network entity is provided that includes transmitting, to one or more UEs, a TDD format configuration indicating at least a portion of multiple time divisions as being configured for downlink data communications from the network entity, and transmitting, to the one or more UEs, an indication scheduling resources for transmitting, by a first UE and in a subset of at least the portion of the multiple time divisions, a signal to enable sensing by the first UE.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for transmitting sensing signals in time divisions configured for downlink (DL) communications, in accordance with aspects described herein;

FIG. 6 is a flow chart illustrating an example of a method for receiving sensing signals in time divisions configured for DL communications, in accordance with aspects described herein;

FIG. 7 is a flow chart illustrating an example of a method for configuring UEs for communicating sensing signals in time divisions configured for DL communications, in accordance with aspects described herein; and

FIG. 8 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to enabling user equipment (UE) sensing in downlink slots by sensing UEs transmitting sensing signals, and/or corresponding reference signals, in the downlink slots. For example, a device, such as a user equipment (UE) in fifth generation (5G) new radio (NR) or other wireless communication technologies, can perform functions related to integrated sensing and communication (ISAC). For example, in automotive applications, vehicle-based UEs can communicate with one another or with other nodes while also transmitting sensing signals to sense certain targets (e.g., objects) around the vehicle, such as pedestrians, other vehicles, etc. Jointly designed sensing and communication system for automotive can have the potential to reduce hardware cost. In a joint sensing and communication system, a vehicle's communication system (e.g., a UE) can transmit signals for sensing, e.g., to detect objects around the vehicle by detecting its echo in a monostatic sensing operation (e.g., where the UE is capable of full duplex (FD) communications). For improved synergy, for example, the communication system may transmit sensing signal in the millimeter wave (mmWave) band that was designated for cellular communication (e.g., in 5G NR), but may currently be underutilized for such purposes. This may be referred to as an in-band operation in the mmWave band.

In some examples, in multiplexing of sensing and communication signals for in-band operation, a sensing signal may be transmitted by a UE in resources of cellular system, for UE monostatic sensing. The sensing signal may use the same or similar waveform as used in 5G NR (e.g., cyclic prefix (CP)-orthogonal frequency division multiplexing (OFDM)) or use a different waveform (e.g., frequency-modulated continuous wave (FMCW)). Moreover, for example, the sensing signal may be scheduled for communication in resources of the cellular system, which can include assigning the sensing signal resources in frequency and/or time divisions defined by the cellular system. Examples of such frequency divisions in 5G NR may include subcarriers, resource elements, resource blocks or multiple resource elements, etc. Examples of such time divisions in 5G NR may include OFDM symbols, slots of multiple OFDM symbols, mini-slots of collections of one or more OFDM symbols within a slot, etc., as described in further detail herein. In addition, for example, a sensing reference signal (RS) may be specified as sensing signal, to meet various sensing requirements. In an example, resources used for sensing RS transmission may be configured or allocated by a network entity, e.g., gNB. Additionally, for example, sensing may use dedicatedly allocated or configured resources, e.g., time division multiplexing (TDM) with communication, or may reuse communication resources.

In some examples, communicating sensing signals can include a two-stage (or multi-stage) sensing for overhead reduction. Sensing resource overhead can depend on sensing service requirement. For example, for UE sensing for automotive, sensing signal bandwidth and duration may need to be large enough for desired range and velocity resolution. Beam-sweeping for sensing signal transmission may be needed as well to achieve desired angular estimate requirement. For applications with high range, velocity, and/or angle resolution requirements, the higher resource overhead can be problematic to the cellular system when utilizing bands of the cellular system.

In one example, two-stage sensing may reduce sensing signal overhead by providing at least a scanning stage and tracking stage. In the scanning stage, a smaller bandwidth and/or duration, and/or a wider beam, (as compared to the tracking stage) can be used to identify the presence of potential targets. In the tracking stage, a larger bandwidth and/or duration, and/or a narrower beam, (as compared to the scanning stage) can be used to detect a target of interest. This may also potentially use less beams to discover the target. Compared with single stage sensing, two-stage (or even multi-stage) sensing may reduce resource overhead in this regard.

In another example, comb-type sensing signal can also reduce overhead. For example, in time-domain comb transmission, sensing signal can be mapped to a fractional number of slots and/or symbols. In one example, a sensing signal can be mapped to every N-th symbol, for a total of M sensing symbols. In this example, the sensing signal transmission can span M*N symbols in time, but may only occupy M symbols. In the above example, the values for M and N can depend on sensing requirement and/or may become restrictive for sensing reference signal (RS) resource configuration/allocation, especially in a time division duplexing (TDD) system.

In 5G NR, for example, in-band sensing can be operated in mmWave system, which is typically configured using TDD. For instance, the mmWave bands that may be suitable for sensing, e.g., 28 gigahertz (GHz), are designated as TDD. The mmWave bands can typically have downlink (DL)-heavy TDD configurations for DL communication throughput boosting, meaning that a majority of the slots, or symbols within a slot, are configured for DL communications. For UE monostatic sensing, the UE may transmit sensing signal in uplink (UL) (or flexible) resource. In two-stage sensing, the UE may transmit first stage sensing RS transmission in UL slots/symbols as the first stage signal may potentially have shorter duration than a second stage signal (e.g., one sensing RS may span <=0.25 milliseconds (ms), which can be about 2 slots for 120 kilohertz (kHz) band). For second stage signal, however, one sensing RS (beam) can span up to 5 ms, which can be about 40 slots, depending on velocity estimation requirements, implying an UL-heavy TDD configuration for accommodating sensing. This may contradict boosting DL throughput using mmWave for communication. Alternatively, a per-slot DL/flexible/UL configuration can be used, but this may incur high overhead.

Accordingly, it may be desirable or beneficial to the cellular system to allow UEs to transmit sensing signals in DL slots/symbols. In this regard, for example, TDD configuration can provide a DL-heavy configuration for DL capacity. Aspects described herein relate to handling potential impact to legacy UE operation and enhancements to the system for handling interference between sensing and communication when sensing RS transmission occurs in DL slots/symbols. For example, a sensing UE, which can refer to the UE transmitting sensing signals for sensing targets, can transmit sensing signals and/or corresponding reference signals for interference measurement in DL slots or symbols. The other UEs that receive downlink communications that may be interfered by, or otherwise have overlapping resources with, the sensing signals can be referred to as communication UEs. Transmitting sensing signals in DL slots can limit impact to legacy UE operations, as the legacy UEs can continue to receive signals in DL slots and may ignore the sensing signals and/or cancel out the sensing signals as interference. In some examples, a network entity can configure the sensing UEs for transmitting the sensing signals in the DL resources and/or the communication UEs for receiving and/or cancelling the sensing signals from DL communications.

As described, using the DL resources for transmitting sensing signals can allow the cellular network to maintain a DL-heavy slot/symbol configuration while allowing sensing signals to reuse the mmWave band. This can also limit impact to legacy UEs. In addition, in some examples, this can allow the network entity to control resources over which sensing signals are transmitted, reschedule DL data communications in some cases to improve sensing signal hearability, and/or the like. The various aspects described herein can improve sensing signal transmission and reception in the cellular system frequency bands.

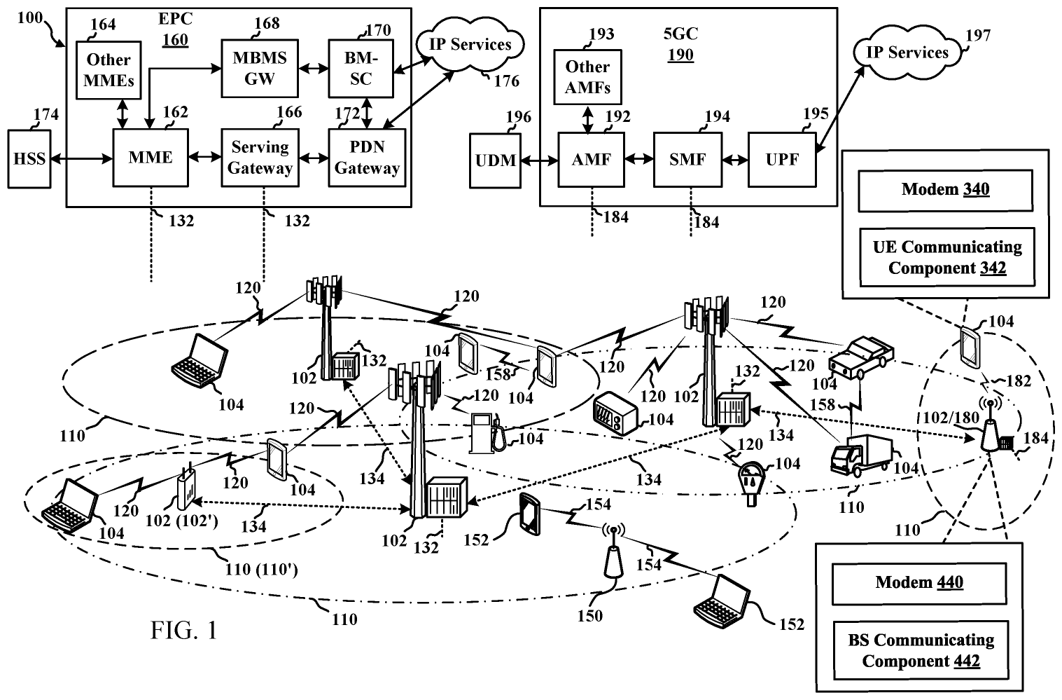

The described features will be presented in more detail below with reference to FIGS. 1-8.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for transmitting and/or receiving downlink signals that overlap resources with sensing signals in a cellular communication band, in accordance with aspects described herein. In addition, some nodes may have a modem 440 and BS communicating component 442 for configuring UEs for transmitting and/or receiving downlink signals that overlap resources with sensing signals in a cellular communication band, in accordance with aspects described herein. Though a UE 104 is shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, UE communicating component 342 of one UE 104, referred to as a sensing UE, can transmit sensing signals. A UE communicating component 342 of another UE 104, referred to as a communication UE, can receive and process downlink signals from the base station 102 that may overlap resources with the sensing signals. In examples described herein, UE communicating component 342 of the sensing UE can transmit the sensing signals, and/or UE communicating component 342 of the communication UE can receive downlink signals that may overlap resources with the sensing signals, in time divisions (e.g., symbols, slots, mini-slots, etc.) that are configured for downlink communications. In one example, BS communicating component 442 of a base station 102 can configure the time divisions for downlink communications based on a slot configuration of multiple slots, or a symbol configuration of multiple symbols, indicating the communication direction of each of the multiple slots or symbols as downlink, uplink, or flexible (e.g., where flexible can be configured for downlink or uplink, or for switching from downlink to uplink, using dynamic signaling).

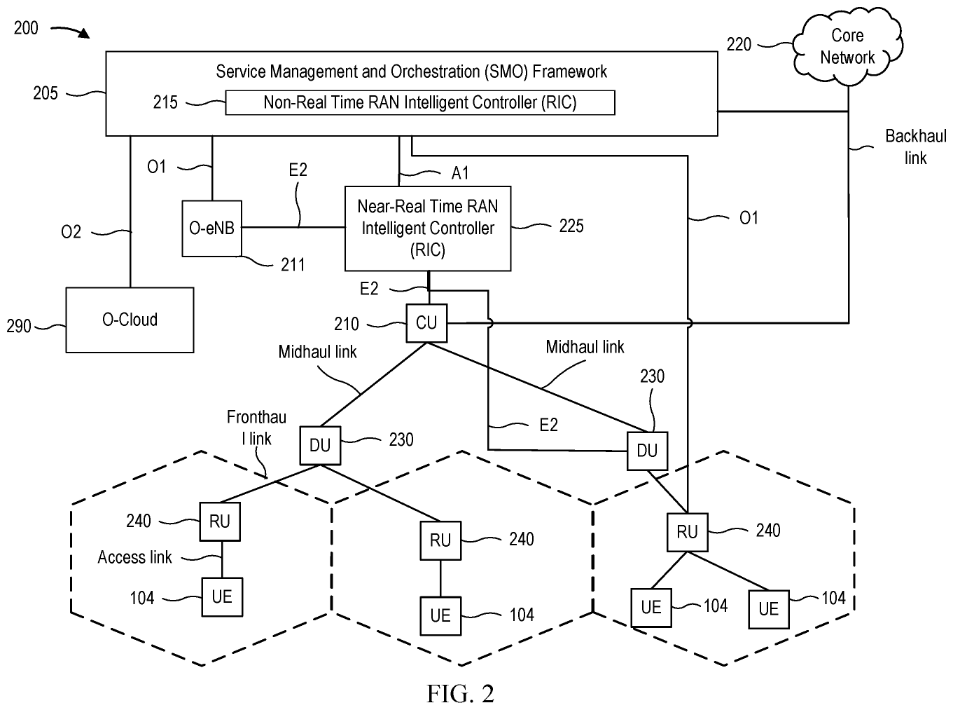

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

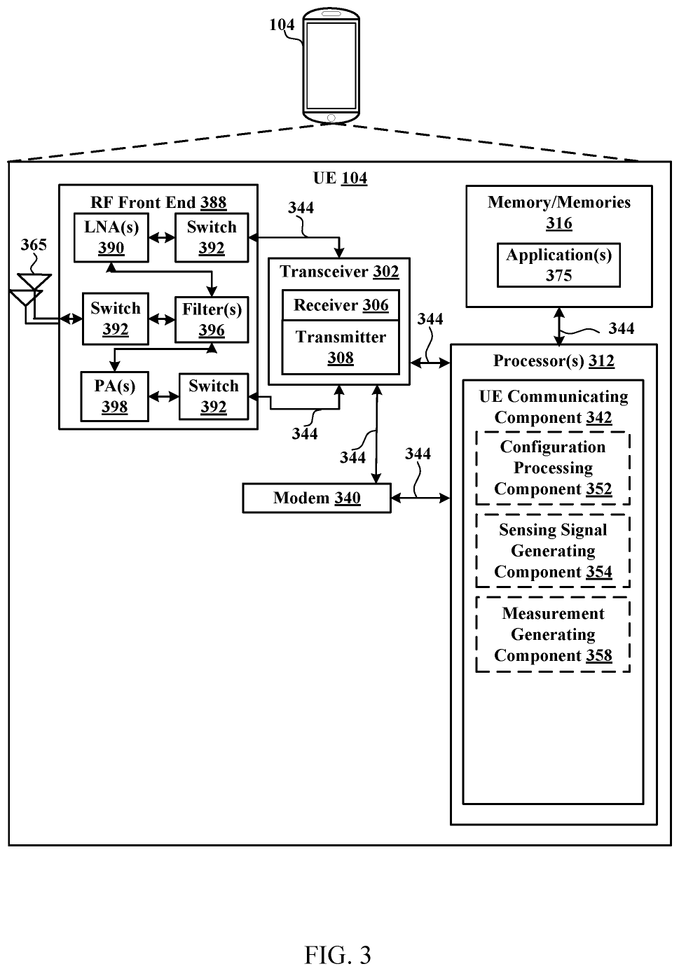

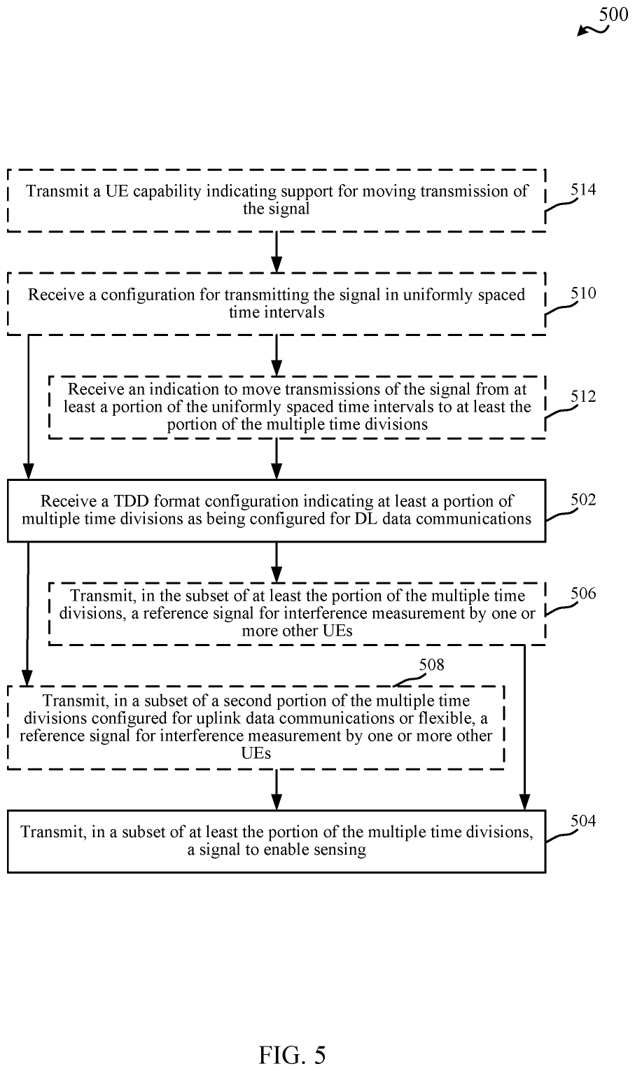

Turning now to FIGS. 3-8, aspects are depicted with reference to one or more components and one or more methods that may perform the actions or operations described herein, where aspects in dashed line may be optional. Although the operations described below in FIGS. 5-7 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and one or more memories 316 and one or more transceivers 302 in communication via one or more buses 344. For example, the one or more processors 312 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 316 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 312, one or more memories 316, and one or more transceivers 302 may operate in conjunction with modem 340 and/or UE communicating component 342 for transmitting and/or receiving downlink signals that may overlap resources with sensing signals in a cellular communication band, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory/memories 316 may be configured to store data used herein and/or local versions of applications 375 or UE communicating component 342 and/or one or more of its subcomponents being executed by at least one processor 312. Memory/memories 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory/memories 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a configuration processing component 352 for receiving and/or processing one or more configurations received from a network entity (or another UE), such as a slot configuration, a reference signal configuration, a sensing signal configuration, etc., a sensing signal generating component 354 for generating and/or transmitting a sensing signal for sensing targets (e.g., objects) in a vicinity of the UE 104, and/or a measurement generating component 358 for generating a signal measurement of a sensing signal or corresponding reference signal, in accordance with aspects described herein.

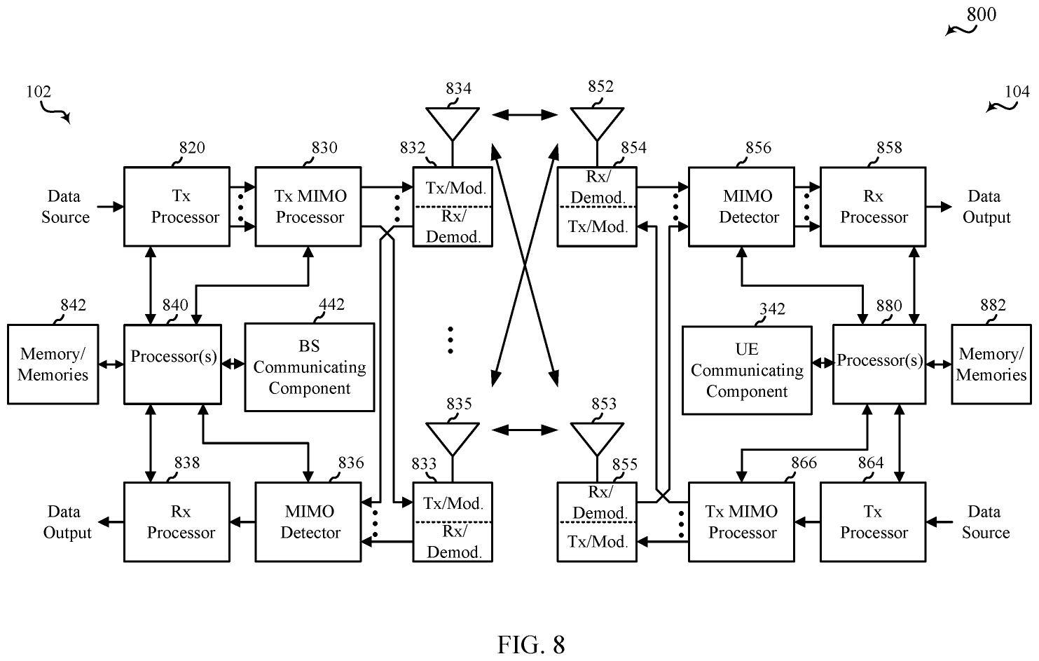

In an aspect, the processor(s) 312 may correspond to one or more of the processors described in connection with the UE in FIG. 8. Similarly, the memory/memories 316 may correspond to the one or more memories described in connection with the UE in FIG. 8.

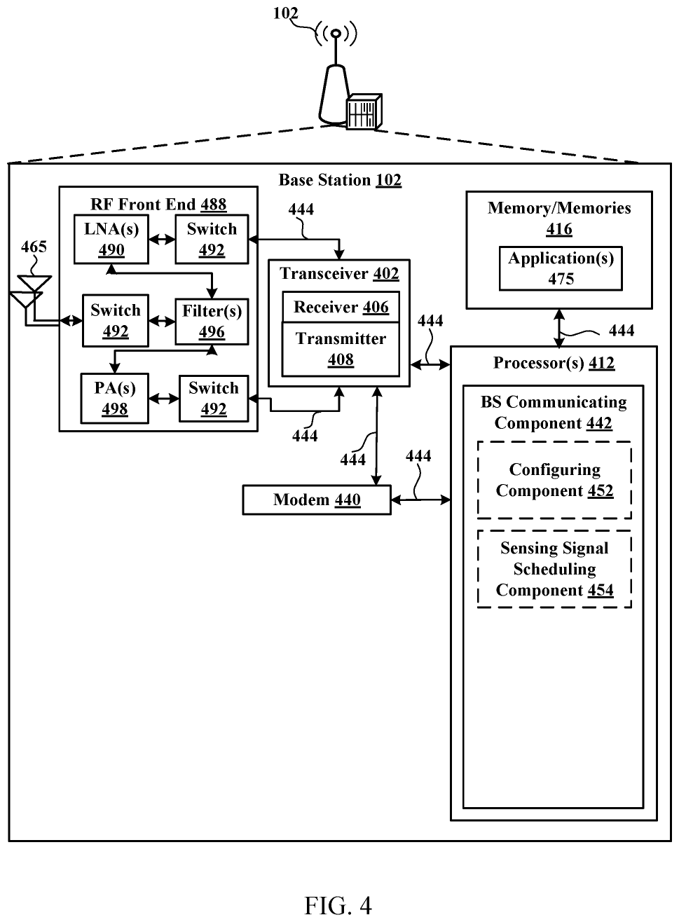

Referring to FIG. 4, one example of an implementation of base station 102 (e.g., a base station 102 and/or gNB 180, as described above) may include a variety of components, some of which have already been described above, but including components such as one or more processors 412 and one or more memories 416 and one or more transceivers 402 in communication via one or more buses 444. For example, the one or more processors 412 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 416 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 412, one or more memories 416, and one or more transceivers 402 may operate in conjunction with modem 440 and/or BS communicating component 442 for configuring UEs for transmitting and/or receiving downlink signals that may overlap resources with sensing signals in a cellular communication band, in accordance with aspects described herein.

The transceiver 402, receiver 406, transmitter 408, one or more processors 412, memory/memories 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a configuring component 452 for generating and/or transmitting one or more configurations to one or more UEs, and/or a sensing signal scheduling component 454 for scheduling sensing signal transmissions in one or more time divisions, which may include DL, UL or flexible symbols or slots or mini-slots, in accordance with aspects described herein.

In an aspect, the processor(s) 412 may correspond to one or more of the processors described in connection with the base station in FIG. 8. Similarly, the memory/memories 416 may correspond to the one or more memories described in connection with the base station in FIG. 8.

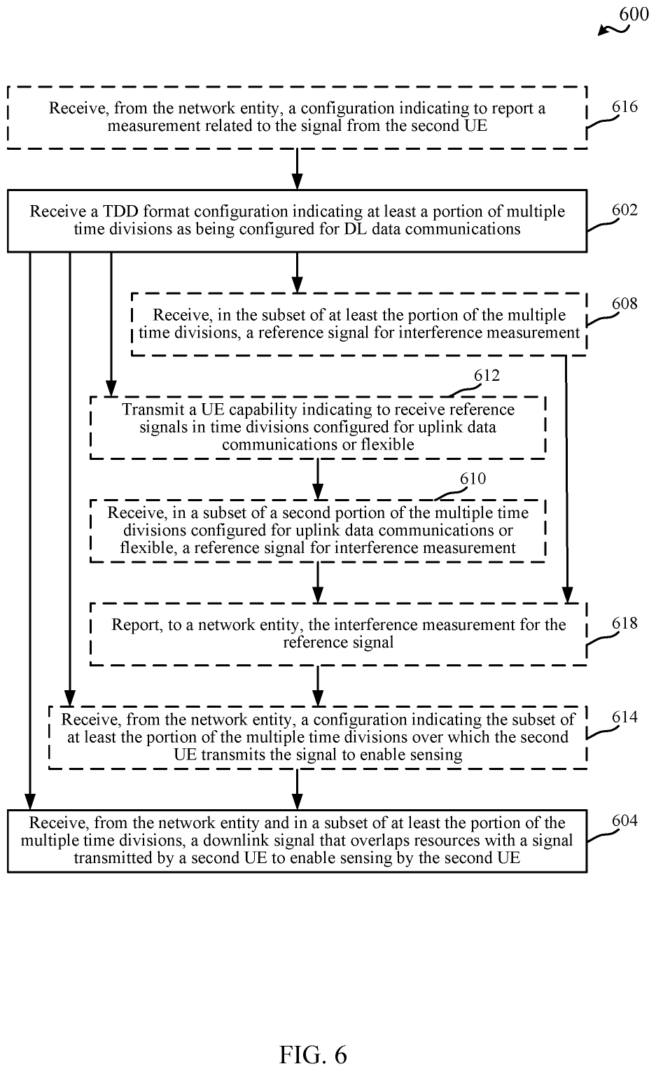

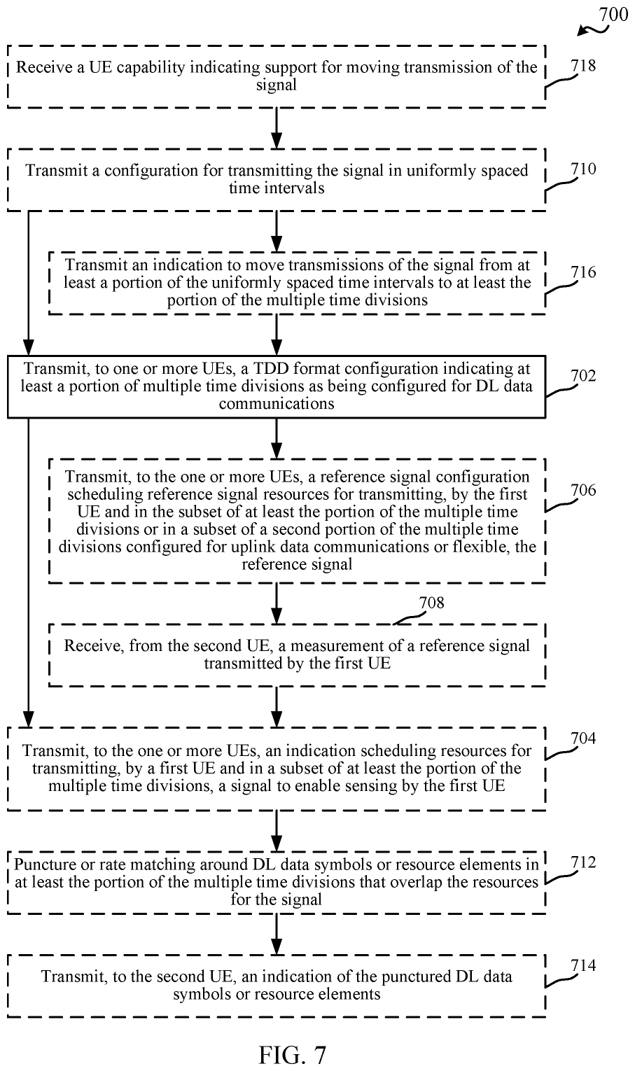

FIG. 5 illustrates a flow chart of an example of a method 500 for transmitting sensing signals in time divisions configured for DL communications, in accordance with aspects described herein. FIG. 6 illustrates a flow chart of an example of a method 600 for receiving downlink signals that may overlap resources with sensing signals in time divisions configured for DL communications, in accordance with aspects described herein. FIG. 7 illustrates a flow chart of an example of a method 700 for configuring UEs for communicating sensing signals in time divisions configured for DL communications, in accordance with aspects described herein. In an example, a sensing UE 104 can perform the functions described in method 500 shown in FIG. 5 using one or more of the components described in FIGS. 1 and/or 3. In an example, a communication UE 104 can perform the functions described in method 600 shown in FIG. 6 using one or more of the components described in FIGS. 1 and/or 3. In an example, a node scheduling the UE 104 with communication resources, such as a base station 102 or gNB 180, a monolithic base station or gNB, a portion of a disaggregated base station or gNB, a UE in sidelink communication, etc., can perform the functions described in method 700 shown in FIG. 7 using one or more of the components described in FIGS. 1 and/or 4. Methods 500, 600, and 700 are described in conjunction with one another for ease of explanation; however, the methods 500, 600, and 700 are not required to be performed together and indeed can be performed independently using separate devices.

In method 700, at Block 702, a TDD format configuration indicating at least a portion of multiple time divisions as being configured for DL communications can be transmitted to one or more UEs. In an aspect, configuring component 452, e.g., in conjunction with processor(s) 412, memory/memories 416, transceiver 402, BS communicating component 442, etc., can transmit, to one or more UEs (e.g., one or more sensing UEs and/or one or more communication UEs), the TDD format configuration indicating at least the portion of multiple time divisions as being configured for DL data communications. For example, configuring component 452 can transmit the TDD format configuration using RRC or other semi-static signaling, may update the TDD format configuration using dynamic signaling, such as downlink control information (DCI), and/or the like. The TDD format configuration may also include one or more time divisions configured for uplink communications or flexible, as described herein. The TDD format may be DL-heavy, meaning a majority of time divisions (or at least a portion greater than a threshold) are configured as DL to promote DL throughput in a cellular communication system. Moreover, for example, the time divisions can be slots, symbols, mini-slots, etc., such that the TDD format configuration indicates, for each slot of multiple slots, each symbol of multiple symbols, etc., the communication direction as DL (“D”), UL (“U”), or flexible (“F”).

In method 500, at Block 502, a TDD format configuration indicating at least a portion of multiple time divisions as being configured for DL communications can be received. In an aspect, configuration processing component 352 of a sensing UE, e.g., in conjunction with processor(s) 312, memory/memories 316, transceiver 302, UE communicating component 342, etc., can receive (e.g., from a network entity) the TDD format configuration indicating at least the portion of multiple time divisions as being configured for DL data communications. In method 600, at Block 602, a TDD format configuration indicating at least a portion of multiple time divisions as being configured for DL communications can be received. In an aspect, configuration processing component 352 of a communication UE, e.g., in conjunction with processor(s) 312, memory/memories 316, transceiver 302, UE communicating component 342, etc., can receive (e.g., from a network entity) the TDD format configuration indicating at least the portion of multiple time divisions as being configured for DL data communications. As described, for example, UE communicating component 342 can receive the TDD format configuration in RRC or other semi-static signaling, receive an update to the TDD format configuration in DCI, etc.

In method 500, at Block 504, a signal can be transmitted, in a subset of at least the portion of the multiple time divisions, to enable sensing. In an aspect, sensing signal generating component 354 of a sensing UE, e.g., in conjunction with processor(s) 312, memory/memories 316, transceiver 302, UE communicating component 342, etc., can generate for transmission, and/or transmit, in the subset of at least the portion of the multiple time divisions, the signal to enable sensing. For example, the signal may include a sensing signal, such as a first stage or second stage sensing signal, as described herein, a reference signal associated with the sensing signal (e.g., to enable interference measurement for the sensing signal or associated resources), and/or the like. The UE 104 can use the sensing signal to sense targets (e.g., objects) in a vicinity of the UE 104. For example, the UE 104 can transmit the sensing signal and measure a corresponding received signal to detect presence of a target (e.g., a pedestrian, vehicle, obstruction, etc.). Using the cellular communication frequency to transmit such signals can provide various benefits described above.

In method 600, at Block 604, a downlink signal can be received, from the network entity and in a subset of at least the portion of the multiple time divisions, that overlaps resources with a signal transmitted by a second UE to enable sensing by the second UE. In an aspect, UE communicating component 342 of a communication UE, e.g., in conjunction with processor(s) 312, memory/memories 316, transceiver 302, etc., can receive and/or process, from the network entity and in the subset of at least the portion of the multiple time divisions, the downlink signal that overlaps resources with the signal transmitted by the second UE (e.g., a sensing UE) to enable sensing by the second UE. In this regard, DL resources of the cellular communication system can be used (or reused) for UEs to communicate sensing signals (or related signals, such as reference signals) with one another, which can allow for keeping the cellular communication system DL focused and using DL resources that may not be fully utilized by the cellular communication system. In some examples, however, the communication UE may know the resources over which sensing signals are transmitted by sensing UEs and/or may in some cases cancel sensing signals from received downlink communications.

In method 700, optionally at Block 704, an indication scheduling resources for transmitting, by a first UE and in a subset of at least the portion of the multiple time divisions, a signal to enable sensing by the first UE can be transmitted to the one or more UEs. In an aspect, sensing signal scheduling component 454, e.g., in conjunction with processor(s) 412, memory/memories 416, transceiver 402, BS communicating component 442, etc., can transmit, to the one or more UEs (e.g., one or more sensing UEs and/or one or more communication UEs), the indication scheduling resources for transmitting, by the first UE (e.g., a sensing UE) and in the subset of at least the portion of the multiple time divisions, the signal to enable sensing by the first UE. For example, sensing signal scheduling component 454 can schedule the resources for the sensing UE to transmit the sensing signal (or signals) and/or to transmit an associated reference signal, as described further herein. In one example, the sensing UE transmitting the signal (e.g., at Block 504) and/or the communication UE receiving downlink signals that may overlap resources with the signal (e.g., at Block 604) can be based on the resource scheduling received from the network entity.

In method 700, optionally at Block 706, a reference signal configuration can be transmitted to the one or more UEs for scheduling reference signal resources for transmitting, by the first UE and in the subset of at least the portion of the multiple time divisions or in a subset of a second portion of the multiple time divisions configured for uplink data communications or flexible. In an aspect, sensing signal scheduling component 454, e.g., in conjunction with processor(s) 412, memory/memories 416, transceiver 402, BS communicating component 442, etc., can transmit, to the one or more UEs, the reference signal configuration scheduling reference signal resources for transmitting, by the first UE and in the subset of at least the portion of the multiple time divisions or in the subset of the second portion of the multiple time divisions configured for uplink data communications or flexible, the reference signal. In this regard, for example, the network entity can configure the sensing UE to transmit the reference signal for interference measurement.

In one example, the network entity can configure the sensing UE to transmit (and/or the communication UE to receive) RS in DL slots/symbols, where the DL slots/symbols can include at least one slot or symbol that has been configured as ‘D’ in the common TDD configuration, as described above. In this example, in method 500, optionally at Block 506, a reference signal for interference measurement by one or more other UEs can be transmitted in the subset of at least the portion of the multiple time divisions. In an aspect, sensing signal generating component 354 of a sensing UE, e.g., in conjunction with processor(s) 312, memory/memories 316, transceiver 302, UE communicating component 342, etc., can generate for transmission, and/or transmit, in the subset of at least the portion of the multiple time divisions, the reference signal for interference measurement by the one or more other UEs. In this example, in method 600, optionally at Block 608, a reference signal for interference measurement can be received in the subset of at least the portion of the multiple time divisions. In an aspect, UE communicating component 342 of a communication UE, e.g., in conjunction with processor(s) 312, memory/memories 316, transceiver 302, etc., can receive and/or process, in the subset of at least the portion of the multiple time divisions, the reference signal for interference measurement.

In another example, the network entity can configure the sensing UE to transmit the RS in UL or flexible slots/symbols (if interference measurement is coherent measurement, e.g., RSRP, the measurement can be consistent regardless of transmitting in DL or UL resource). In this example, in method 500, optionally at Block 508, a reference signal for interference measurement by one or more other UEs can be transmitted in a subset of a second portion of the multiple time divisions configured for uplink data communications or flexible. In an aspect, sensing signal generating component 354 of a sensing UE, e.g., in conjunction with processor(s) 312, memory/memories 316, transceiver 302, UE communicating component 342, etc., can generate for transmission, and/or transmit, in the subset of the second portion of the multiple time divisions configured for uplink data communications or flexible, the reference signal for interference measurement by the one or more other UEs. In this example, in method 600, optionally at Block 610, a reference signal for interference measurement can be received in a subset of a second portion of the multiple time divisions configured for uplink data communications or flexible. In an aspect, UE communicating component 342 of a communication UE, e.g., in conjunction with processor(s) 312, memory/memories 316, transceiver 302, etc., can receive and/or process, in the subset of the second portion of the multiple time divisions configured for uplink data communications or flexible, the reference signal for interference measurement.

In an example, the network entity can configure communication UEs that indicate support for receiving downlink communications that may overlap resources with sensing signals. In this example, in method 600, optionally at Block 612, a UE capability indicating to receive reference signals in time divisions configured for uplink data communications or flexible can be transmitted. In an aspect, UE communicating component 342 of a communication UE, e.g., in conjunction with processor(s) 312, memory/memories 316, transceiver 302, etc., transmit (e.g., to the network entity) the UE capability indicating to receive reference signals in time divisions configured for uplink communications or flexible. For example, UE communicating component 342 can transmit the UE capability in RRC or other signaling to the network entity. In an example, configuring component 452 of the network entity can receive the UE capability information and can accordingly schedule the resources for the communication UE (e.g., at Block 704).

In method 600, optionally at Block 614, a configuration indicating the subset of at least the portion of the multiple time divisions over which the second UE transmits the signal to enable sensing. In an aspect, configuration processing component 352 of a communication UE, e.g., in conjunction with processor(s) 312, memory/memories 316, transceiver 302, UE communicating component 342, etc., can receive, from the network entity, the configuration indicating the subset of at least the portion of the multiple time divisions over which the second UE transmits the signal to enable sensing by the second UE. UE communicating component 342 can accordingly receive and process DL signals received from the network entity though the resources may overlap with resources used by the second UE (e.g., the sensing UE) to send sensing signals. In one example, UE communicating component 342 can cancel interference from the sensing signals transmitted by the sensing UE, if needed.

In one example, the sensing UE can transmit the RS as a dedicated interference measurement RS (e.g., sounding reference signal (SRS)). The dedicated interference measurement RS can be quasi-colocated with a sensing RS transmitted by the sensing UE (e.g., can have the same beam direction, power, etc., as the sensing RS). For example, the sensing RS can be transmitted by the sensing UE at Block 504 and/or received by the communication UE at Block 604. In another example, the sensing UE can transmit the RS as a first stage sensing RS (e.g., in UL resource). In this example, the first stage sensing RS can also be used for interference measurement and/or sensing resource allocation for a second stage sensing RS in DL resource (e.g., as transmitted by the sensing UE at Block 504 or received by the communication UE at Block 604) may be based on the interference measurement from the first stage sensing RS.

In transmitting the reference signal configuration (e.g., at Block 706), sensing signal scheduling component 454 can configure the communication UE to report reference signal measurements for the reference signal (e.g., whether as a dedicated interference measurement RS or a first stage sensing signal). In an example, in method 600, optionally at Block 616, a configuration indicating to report a measurement related to the signal from the second UE can be received from the network entity. In an aspect, configuration processing component 352 of a communication UE, e.g., in conjunction with processor(s) 312, memory/memories 316, transceiver 302, UE communicating component 342, etc., can receive, from the network entity, the configuration indicating to report the measurement related to the signal from the second UE. For example, configuration processing component 352 can receive the configuration in RRC signaling from the network entity or in dynamic signaling, such as DCI, and the configuration can indicate resources related to the RS transmitted by the sensing UE for which the communication UE is to provide measurements (e.g., RSRP measurements). In this regard, the network entity can configure, in one example, the communication UE measuring the RS. For example, the network entity can indicate the RS configuration to communication UE, and the communication UE can measure the RS to determine interference level/power from potential sensing RS transmission. The communication UE can be a potential victim UE that would be receiving in DL slots/symbols that may have sensing RS transmission from sensing UE.

In method 600, optionally at Block 618, the interference measurement for the reference signal can be reported to the network entity. In an aspect, measurement generating component 358 of a communication UE, e.g., in conjunction with processor(s) 312, memory/memories 316, transceiver 302, UE communicating component 342, etc., can receive and measure the RS received from the sensing UE in the resources indicated by the configuration and/or report the interference measurement for the reference signal to the network entity, where the RS can be a dedicated RS for interference measurement, a first stage sensing RS, etc., as described. In method 700, optionally at Block 708, a measurement of a reference signal transmitted by the first UE can be received from the second UE. In an aspect, BS communicating component 442, e.g., in conjunction with processor(s) 412, memory/memories 416, transceiver 402, etc., can receive, from the second UE (e.g., the communication UE), a measurement of a reference signal transmitted by the first UE (e.g., the sensing UE). In an example, configuring component 452 can determine a resource allocation for a subsequent signal (e.g., a sensing signal where the RS is a dedicated interference management RS, a second stage sensing signal where the RS is a first stage sensing signal, etc.), and can transmit the indication scheduling resources at Block 704 based on the RS measurements received from the communication UE.

In one example, in transmitting the reference signal configuration for the sensing UE (e.g., at Block 706), configuring component 452 can configure the measurement RS in D, F, or U resource. In one example, configuring component 452 can configure the RS in D resource, which can be backward compatible with legacy communication UE that only receive in D. In this example, the sensing UE can transmit in D resource (e.g., D slots/symbols configured by common TDD configuration), for the RS and/or sensing RS. In another example, configuring component 452 can configure the RS in F or U resource. In this example, the sensing UE can transmit in the F or U resource for the RS, and the communication UE can receive in the F or U resource for the RS. In another example, transmission and/or reception of the RS in D resources and in U/F resources can be supported. In this example, configuring component 452 can configure communication UE to measure, and/or sensing UE to transmit, RS based on communication UE capability (e.g., whether the communication UE is able to receive in F/U slots/symbols for interference measurement, which the communication UE may indicate in UE capability information signaled to the network entity).

In another example, sensing signal generating component 354 can generate the interference measurement RS to be quasi-colocated with the sensing signal (or sensing RS). As described, in one example, the interference measurement RS can be a dedicated RS for interference measurement, e.g., SRS, which is sent by sensing UE at the same beam direction as sensing RS. In this example, beam sweeping may be used where the sensing UE can transmit multiple interference measurement RSs (e.g., multiple SRS transmissions) in different beam directions the same as sensing RS. In this example, the communication UE can receive the interference measurement RSs and may report measurements thereof, as described, which can be used to determine the beam direction for sensing UE to use in transmitting sensing signals for sensing targets. In another example, the interference measurement RS can be the first stage sensing RS sent in F and/or U resource (first stage sensing RS may use less resources than the second stage sensing signal, so it can be incorporated in UL resource without significantly interfering with DL communication). In an example, the communication UE can be configured to measure the first stage sensing RS for interference (e.g., RSRP measurement), as described above.

In an example, as described above, configuring component 452 can configure one or multiple communication UE(s) to measure the RS. For example, the network entity (e.g., gNB/BS) can send the RS configuration to communication UE(s), and the communication UE(s) can measure the RSs from sensing UE(s) based on the configuration. The communication UE may be configured to report, e.g., via measurement generating component 358, the measurement to the network entity. In one example, the communication UE can report cross link interference (CLI)-RSSI and/or SRS-RSRP) (e.g., at Block 618). In another example, measurement generating component 358 can report the measurement of the RS along with (e.g., merged with) channel state information (CSI) reporting. For example, the communication UE can report CSI, which can account for interference from the RS of the sensing UE (e.g., higher interference may lead to smaller channel quality indicator (CQI)), and the reported CSI can be the report transmitted to the network entity by measurement generating component 358 (e.g., at Block 618). In yet another example, the network entity can configure and/or indicate (e.g., in the reference signal configuration) an RSSI threshold and/or an RSRP threshold to the communication UE. For example, the communication UE can report to the network entity (e.g., at Block 618) whether measured RSSI and/or RSRP exceeds the threshold.

In an example, in scheduling resources for the sensing RS, the network entity may prioritize sensing RS transmission over other (e.g., DL) transmissions. For example, for a sensing coherent processing interval (CPI), or a coherent sensing RS transmission, configuring component 452 can configure uniform sensing RS time divisions (e.g., symbols or slots) that are uniform in time (e.g., periodic) within the CPI for Doppler estimation (e.g., a fast Fourier transform (FFT) operation in time direction). In this example, the network entity may prioritize sensing RS resource allocation for sensing UE to achieve the uniformity across time divisions. For example, in method 700, optionally at Block 710, a configuration for transmitting the signals in uniformly spaced time intervals can be transmitted. In an aspect, configuring component 452, e.g., in conjunction with processor(s) 412, memory/memories 416, transceiver 402, BS communicating component 442, etc., can transmit (e.g., to the sensing UE) a configuration for transmitting the signal in uniformly spaced time intervals. For example, this can be part of the reference signal configuration transmitted at Block 706 or another configuration. In an example, configuring component 452 can indicate the uniformly spaced time intervals based on a periodicity of the time intervals, a starting index, an interval, etc. In method 500, optionally at Block 510, a configuration for transmitting the signal in uniformly spaced time intervals can be received. In an aspect, configuration processing component 352, e.g., in conjunction with processor(s) 312, memory/memories 316, transceiver 302, UE communicating component 342, etc., can receive (e.g., from the network entity) the configuration for transmitting the signal in uniformly spaced time intervals. In an example, sensing signal generating component 354 can generate the sensing signal for transmission based on this configuration, and can accordingly transmit the sensing signal in uniformly spaced time intervals (e.g., at Block 504).

In this example, the network entity may handle potentially conflicting DL transmission for communication UE using various mechanisms. For example, the network entity may schedule, e.g., via configuring component 452, a communication UE receiving in a DL resource that conflicts or overlaps with sensing RS transmission from sensing UE if the RS measurement from the communication UE is sufficient to indicate that multiplexing is feasible (e.g., the measurement indicates interference below certain threshold configured at the network entity).

In another example, the network entity may determine to schedule a communication UE receiving a DL transmission, which overlaps with a sensing signal, in an orthogonal resource, e.g., by using mini-slots to avoid symbols used by sensing UE for sensing RS transmission. In this example, configuring component 452 can schedule the communication UE in a mini-slot of the same slot used by the sensing UE for transmitting the sensing signal, where the mini-slot does not conflict with, or overlap, the sensing signal transmission.

In yet another example, the network entity may determine puncturing a symbols or resource elements (REs) of a scheduled DL transmission (e.g., physical downlink shared channel (PDSCH)) that conflict with sensing RS resource. For example, when interference is high in these symbols or REs, transmitting PDSCH in these symbols or REs may not be effective, so BS communicating component 442 can accordingly puncture the symbols or REs, so as not to transmit the DL signals in these symbols or REs. This may be transparent to the communication UE that may otherwise receive the DL transmissions. In yet another example, configuring component 452 can indicate, to the communication UE (e.g., in the reference signal configuration) the symbols or REs being punctured. In this example, the communication UE can receive the configuration (e.g., at Block 616 or 618) or other indication to skip these symbols or REs while receiving the DL transmissions to prevent adding bad log likelihood ratios (LLR) to its receiving buffer, which may otherwise degrade performance. In yet another example, the network entity may determine to rate match around symbols used for sensing RS resource, and/or can indicate to the communication UE to perform the rate matching.

In these examples, in method 700, optionally at Block 712, DL data symbols or REs can be punctured or rate matched around in at least the portion of the multiple time divisions that overlap the resources for the signal. In an aspect, BS communicating component 442, e.g., in conjunction with processor(s) 412, memory/memories 416, transceiver 402, etc., can puncture or rate match around the DL data symbols or REs in at least the portion of the multiple time divisions that overlap the resources for the signal. In addition, in method 700, optionally at Block 714, an indication of the punctured DL data symbols or REs can be transmitted to the second UE. In an aspect, configuring component 452, e.g., in conjunction with processor(s) 412, memory/memories 416, transceiver 402, BS communicating component 442, etc., can transmit, to the second UE, the indication of the punctured DL data symbols or REs. As described, the communication UE can use the indication to exclude the punctured DL data symbols or REs in receiving the DL signaling or to similarly rate match around the data symbols or REs.

In an example, in scheduling resources for the sensing RS, the network entity may not prioritize sensing RS transmission over other (e.g., DL) transmissions. For example, when sensing RS is not prioritized, the network entity may move sensing RS transmission in some of the symbols to prioritize DL transmission (or other communications). As a result, the sensing RS within a sensing RS transmission (e.g., CPI) may no longer be uniformly spaced. Sensing (e.g., Doppler estimation) may still be performed by the sensing UE, but more complicated receiver algorithm may be used. In one example, the network entity may schedule a communication UE receiving in a DL resource that conflicts or overlaps with sensing RS transmission from sensing UE if the measurement of the interference measurement RS received from the communication UE indicates that multiplex is feasible, as described.

In another example, the network entity may determine to move one or more of the RS symbols within a sensing RS transmission to different resources. For example, originally configured sensing RS can have uniform symbol interval, as described above (e.g., last symbol of each slot for a duration of 20 slots). In an example, the network entity may decide to move some of the RS symbols to different resource due to measured interference from communication UE exceeding a threshold (e.g., in this 20 slots CPI example, sensing RS symbol within slot #2 and slot #8 can be moved to slot #21 and #22 due to strong interference from sensing RS to a communication UE, for which the communication UE may need to be scheduled in slot #2 and #8 for DL transmission). In one example, the uniformly spaced RS symbols may be configured by RRC to the UE, while DCI signaling or MAC CE from network entity may be used to modify resource configuration due to potential conflict/interference between communication and sensing UEs. In one example, modification to sensing RS resource configuration may be dependent on UE capability, e.g., whether sensing UE is able to perform sensing based on non-uniform sensing RS interval.

In these examples, in method 700, optionally at Block 716, an indication to move transmissions of the signal from at least a portion of the uniformly spaced time intervals to at least the portion of the multiple time divisions can be transmitted. In an aspect, configuring component 452, e.g., in conjunction with processor(s) 412, memory/memories 416, transceiver 402, BS communicating component 442, etc., can transmit the indication to move transmissions of the signal from at least the portion of the uniformly spaced time intervals to at least the portion of the multiple time divisions. For example, configuring component 452 can transmit the indication to the sensing UE in RRC signaling, DCI, etc., based on determining that the sensing signal from the sensing UE conflicts with or overlaps the resources for the DL transmission. In method 500, optionally at Block 512, an indication to move transmissions of the signal from at least a portion of the uniformly spaced time intervals to at least the portion of the multiple time divisions can be received. In an aspect, configuration processing component 352, e.g., in conjunction with processor(s) 312, memory/memories 316, transceiver 302, UE communicating component 342, etc., can receive the indication to move transmissions of the signal from at least the portion of the uniformly spaced time intervals to at least the portion of the multiple time divisions. Sensing signal generating component 354 can accordingly schedule the sensing signal for transmission in at least the portion of the multiple time divisions.

As described, this functionality can be based on the sensing UE transmitting UE capability information indicating support for such features. Accordingly, in method 500, optionally at Block 514, a UE capability indicating support for moving transmission of the signal can be transmitted. In an aspect, sensing signal generating component 354, e.g., in conjunction with processor(s) 312, memory/memories 316, transceiver 302, UE communicating component 342, etc., can transmit (e.g., to the network entity) the UE capability indicating support for moving transmission of the signal. For example, sensing signal generating component 354 can transmit the UE capability in RRC or other semi-static signaling to the network entity, in dynamic signaling, etc. In method 700, optionally at Block 718, a UE capability indicating support for moving transmission of the signal can be received. In an aspect, configuring component 452, e.g., in conjunction with processor(s) 412, memory/memories 416, transceiver 402, BS communicating component 442, etc., can receive (e.g., from a sensing UE) the UE capability indicating support for moving transmission of the signal. In this regard, for example, configuring component 452 can move sensing signal resources from uniformly spaced resources, as described above, to give priority to other transmissions that overlap or conflict with the uniformly spaced resources (and/or where signal measurements from the communication UE prevent multiplexing the other transmissions with the sensing signals in the uniformly spaced resources).

FIG. 8 is a block diagram of a MIMO communication system 800 including a base station 102 and a UE 104. The MIMO communication system 800 may illustrate aspects of the wireless communication access network 100 described with reference to FIG. 1. The base station 102 may be an example of aspects of the base station 102 described with reference to FIG. 1. The base station 102 may be equipped with antennas 834 and 835, and the UE 104 may be equipped with antennas 852 and 853. In the MIMO communication system 800, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 820 may receive data from a data source. The transmit processor 820 may process the data. The transmit processor 820 may also generate control symbols or reference symbols. A transmit MIMO processor 830 may perform spatial processing (e.g., precoding) on data symbols, control symbols, or reference symbols, if applicable, and may provide output symbol streams to the transmit modulator/demodulators 832 and 833. Each modulator/demodulator 832 through 833 may process a respective output symbol stream (e.g., for OFDM, etc.) to obtain an output sample stream. Each modulator/demodulator 832 through 833 may further process (e.g., convert to analog, amplify, filter, and upconvert) the output sample stream to obtain a DL signal. In one example, DL signals from modulator/demodulators 832 and 833 may be transmitted via the antennas 834 and 835, respectively.

The UE 104 may be an example of aspects of the UEs 104 described with reference to FIGS. 1 and 3. At the UE 104, the UE antennas 852 and 853 may receive the DL signals from the base station 102 and may provide the received signals to the modulator/demodulators 854 and 855, respectively. Each modulator/demodulator 854 through 855 may condition (e.g., filter, amplify, downconvert, and digitize) a respective received signal to obtain input samples. Each modulator/demodulator 854 through 855 may further process the input samples (e.g., for OFDM, etc.) to obtain received symbols. A MIMO detector 856 may obtain received symbols from the modulator/demodulators 854 and 855, perform MIMO detection on the received symbols, if applicable, and provide detected symbols. A receive (Rx) processor 858 may process (e.g., demodulate, deinterleave, and decode) the detected symbols, providing decoded data for the UE 104 to a data output, and provide decoded control information to a processor(s) 880, or memory/memories 882.

The processor(s) 880 may in some cases execute stored instructions to instantiate a UE communicating component 342 (see e.g., FIGS. 1 and 3).

On the uplink (UL), at the UE 104, a transmit processor 864 may receive and process data from a data source. The transmit processor 864 may also generate reference symbols for a reference signal. The symbols from the transmit processor 864 may be precoded by a transmit MIMO processor 866 if applicable, further processed by the modulator/demodulators 854 and 855 (e.g., for single carrier-FDMA, etc.), and be transmitted to the base station 102 in accordance with the communication parameters received from the base station 102. At the base station 102, the UL signals from the UE 104 may be received by the antennas 834 and 835, processed by the modulator/demodulators 832 and 833, detected by a MIMO detector 836 if applicable, and further processed by a receive processor 838. The receive processor 838 may provide decoded data to a data output and to the processor(s) 840 or memory/memories 842.

The processor(s) 840 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 800. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 800.

The following aspects are illustrative only and aspects thereof may be combined with aspects of other embodiments or teaching described herein, without limitation.

Aspect 1 is a method for wireless communications at a UE including receiving, from a network entity, a TDD format configuration indicating at least a portion of multiple time divisions as being configured for downlink data communications from the network entity, and transmitting, in a subset of at least the portion of the multiple time divisions, a signal to enable sensing by the UE.

In Aspect 2, the method of Aspect 1 includes transmitting, in the subset of at least the portion of the multiple time divisions or another subset of at least the portion of the multiple time divisions, a reference signal for interference measurement by one or more other UEs.

In Aspect 3, the method of Aspect 2 includes where the reference signal is quasi-colocated with the signal to enable sensing.

In Aspect 4, the method of any of Aspects 1 to 3 includes transmitting, in a subset of a second portion of the multiple time divisions configured for uplink data communications from the UE or flexible, a reference signal for interference measurement by one or more other UEs.

In Aspect 5, the method of Aspect 4 includes where transmitting the reference signal in the second portion of the multiple time divisions is based on a UE capability indicated by the one or more other UEs to receive reference signals in time divisions configured for uplink data communications or flexible.

In Aspect 6, the method of any of Aspects 4 or 5 includes where the reference signal is a first stage sensing reference signal, the signal to enable sensing is a second stage signal, and the reference signal is quasi-colocated with the signal to enable sensing.

In Aspect 7, the method of any of Aspects 1 to 6 includes receiving, from the network entity, a configuration for transmitting the signal in uniformly spaced time intervals, and receiving, from the network entity, an indication to move transmissions of the signal from at least a portion of the uniformly spaced time intervals to at least the portion of the multiple time divisions.

In Aspect 8, the method of Aspect 7 includes transmitting, to the network entity, a UE capability indicating support for moving transmission of the signal, where receiving the indication is based on transmitting the UE capability.

Aspect 9 is a method for wireless communications at a UE including receiving, from a network entity, a TDD format configuration indicating at least a portion of multiple time divisions as being configured for downlink data communications from the network entity, and receiving, from the network entity and in a subset of at least the portion of the multiple time divisions, a downlink signal that overlaps resources with a signal transmitted by a second UE to enable sensing by the second UE.

In Aspect 10, the method of Aspect 9 includes receiving, in the subset of at least the portion of the multiple time divisions or another subset of at least the portion of the multiple time divisions, a reference signal for interference measurement, and reporting, to the network entity, the interference measurement for the reference signal.

In Aspect 11, the method of Aspect 10 includes where the reference signal is quasi-colocated with the signal to enable sensing.

In Aspect 12, the method of any of Aspects 9 to 11 includes receiving, in a second portion of the multiple time divisions configured for uplink data communications from the second UE or flexible, a reference signal for interference measurement, and reporting, to the network entity, the interference measurement for the reference signal.

In Aspect 13, the method of Aspect 12 includes transmitting a UE capability to receive reference signals in time divisions configured for uplink data communications or flexible, where receiving the reference signal in the second portion of the multiple time divisions is based on the UE capability.

In Aspect 14, the method of any of Aspects 12 or 13 includes where the reference signal is a first stage sensing reference signal, the signal to enable sensing is a second stage signal, and the reference signal is quasi-colocated with the signal to enable sensing.

In Aspect 15, the method of any of Aspects 9 to 14 includes receiving, from the network entity, a configuration indicating the subset of at least the portion of the multiple time divisions over which the second UE transmits the signal to enable sensing.

In Aspect 16, the method of any of Aspects 9 to 15 includes receiving, from the network entity, a configuration indicating to report a measurement related to the signal from the second UE, and transmitting, to the network entity and based on the configuration, the measurement related to the signal from the second UE.

In Aspect 17, the method of Aspect 16 includes where the configuration corresponds to a CSI reporting configuration, and where transmitting the measurement includes transmitting a CSI measurement considering the signal from the second UE.

In Aspect 18, the method of any of Aspects 16 or 17 includes where the configuration indicates a signal strength threshold, and where transmitting the measurement includes transmitting an indication of whether the measurement achieves the signal strength threshold.

Aspect 19 is a method for wireless communications at a network entity that includes transmitting, to one or more UEs, a TDD format configuration indicating at least a portion of multiple time divisions as being configured for downlink data communications from the network entity, and transmitting, to the one or more UEs, an indication scheduling resources for transmitting, by a first UE and in a subset of at least the portion of the multiple time divisions, a signal to enable sensing by the first UE.

In Aspect 20, the method of Aspect 19 includes receiving, from a second UE, a measurement of a reference signal, where transmitting the indication is based on the measurement.

In Aspect 21, the method of any of Aspects 19 or 20 includes transmitting, to the one or more UEs, a reference signal configuration scheduling reference signal resources for transmitting, by the first UE and in the subset of at least the portion of the multiple time divisions or in a subset of a second portion of the multiple time divisions configured for uplink data communications from the first UE or flexible, the reference signal.

In Aspect 22, the method of any of Aspects 19 to 21 includes where the resources are orthogonal in frequency to other resources in at least the portion of the multiple time divisions scheduled for the downlink data communications.

In Aspect 23, the method of any of Aspects 19 to 22 includes puncturing downlink data symbols or resource elements in at least the portion of the multiple time divisions that overlap the resources for the signal.

In Aspect 24, the method of Aspect 23 includes transmitting, to a second UE, an indication of the punctured downlink data symbols or resource elements.

In Aspect 25, the method of any of Aspects 19 to 24 includes rate matching around downlink data symbols or resource elements in at least the portion of the multiple time divisions that overlap the resources for the signal.

In Aspect 26, the method of any of Aspects 19 to 25 includes where the resources are moved from uniformly spaced resources that are initially configured for transmitting, by the first UE, the signal to enable sensing.

In Aspect 27, the method of Aspect 26 includes transmitting, to the first UE, a semi-static configuration indicating the uniformly spaced resources.

In Aspect 28, the method of Aspect 27 includes transmitting, to the first UE, a dynamic configuration indicating moving of the uniformly spaced resources.

In Aspect 29, the method of any of Aspects 26 to 28 includes receiving, from the first UE, a UE capability indicating support for non-uniform sensing, where moving the resources from the uniformly spaced resources is based at least in part on the UE capability.

Aspect 30 is an apparatus for wireless communication including one or more processors, one or more memories coupled with the one or more processors, and instructions stored in the one or more memories and operable, when executed by the one or more processors, to cause the apparatus to perform any of the methods of Aspects 1 to 29.

Aspect 31 is an apparatus for wireless communication including means for performing any of the methods of Aspects 1 to 29.

Aspect 32 is one or more computer-readable media including code executable by one or more processors for wireless communications, the code including code for performing any of the methods of Aspects 1 to 29.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
receive, from a network entity, a time division duplexing (TDD) format configuration indicating at least a portion of multiple time divisions as being configured for downlink data communications from the network entity; and
transmit, in a subset of at least the portion of the multiple time divisions, a signal to enable sensing by the apparatus.

2. The apparatus of claim 1, wherein the one or more processors are, individually or in combination, configured to execute the instructions to cause the apparatus to transmit, in the subset of at least the portion of the multiple time divisions or another subset of at least the portion of the multiple time divisions, a reference signal for interference measurement by one or more other user equipments (UEs).

3. The apparatus of claim 2, wherein the reference signal is quasi-colocated with the signal to enable sensing.

4. The apparatus of claim 1, wherein the one or more processors are, individually or in combination, configured to execute the instructions to cause the apparatus to transmit, in a subset of a second portion of the multiple time divisions configured for uplink data communications from the apparatus or flexible, a reference signal for interference measurement by one or more other user equipments (UEs).

5. The apparatus of claim 4, wherein the one or more processors are, individually or in combination, configured to execute the instructions to cause the apparatus to transmit the reference signal in the second portion of the multiple time divisions based on a user equipment (UE) capability indicated by the one or more other UEs to receive reference signals in time divisions configured for uplink data communications or flexible.

6. The apparatus of claim 4, wherein the reference signal is a first stage sensing reference signal, the signal to enable sensing is a second stage signal, and the reference signal is quasi-colocated with the signal to enable sensing.

7. The apparatus of claim 1, wherein the one or more processors are, individually or in combination, configured to execute the instructions to cause the apparatus to:
receive, from the network entity, a configuration for transmitting the signal in uniformly spaced time intervals; and
receive, from the network entity, an indication to move transmissions of the signal from at least a portion of the uniformly spaced time intervals to at least the portion of the multiple time divisions.

8. The apparatus of claim 7, wherein the one or more processors are, individually or in combination, configured to execute the instructions to cause the apparatus to transmit, to the network entity, a user equipment (UE) capability indicating support for moving transmission of the signal, wherein the one or more processors are, individually or in combination, configured to execute the instructions to cause the apparatus to receive the indication based on transmitting the UE capability.

9. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
receive, from a network entity, a time division duplexing (TDD) format configuration indicating at least a portion of multiple time divisions as being configured for downlink data communications from the network entity; and
receive, from the network entity and in a subset of at least the portion of the multiple time divisions, a downlink signal that overlaps resources with a signal transmitted by a second user equipment (UE) to enable sensing by the second UE.

10. The apparatus of claim 9, wherein the one or more processors are, individually or in combination, configured to execute the instructions to cause the apparatus to:
receive, in the subset of at least the portion of the multiple time divisions or another subset of at least the portion of the multiple time divisions, a reference signal for interference measurement; and
report, to the network entity, the interference measurement for the reference signal.

11. The apparatus of claim 10, wherein the reference signal is quasi-colocated with the signal to enable sensing.

12. The apparatus of claim 9, wherein the one or more processors are, individually or in combination, configured to execute the instructions to cause the apparatus to:
receive, in a second portion of the multiple time divisions configured for uplink data communications from the second UE or flexible, a reference signal for interference measurement; and
report, to the network entity, the interference measurement for the reference signal.

13. The apparatus of claim 12, wherein the one or more processors are, individually or in combination, configured to execute the instructions to cause the apparatus to transmit a UE capability to receive reference signals in time divisions configured for uplink data communications or flexible, wherein the one or more processors are, individually or in combination, configured to execute the instructions to cause the apparatus to receive the reference signal in the second portion of the multiple time divisions based on the UE capability.

14. The apparatus of claim 12, wherein the reference signal is a first stage sensing reference signal, the signal to enable sensing is a second stage signal, and the reference signal is quasi-colocated with the signal to enable sensing.

15. The apparatus of claim 9, wherein the one or more processors are, individually or in combination, configured to execute the instructions to cause the apparatus to receive, from the network entity, a configuration indicating the subset of at least the portion of the multiple time divisions over which the second UE transmits the signal to enable sensing.

16. The apparatus of claim 9, wherein the one or more processors are, individually or in combination, configured to execute the instructions to cause the apparatus to:
receive, from the network entity, a configuration indicating to report a measurement related to the signal from the second UE; and
transmit, to the network entity and based on the configuration, the measurement related to the signal from the second UE.

17. The apparatus of claim 16, wherein the configuration corresponds to a channel state information (CSI) reporting configuration, and wherein the one or more processors are, individually or in combination, configured to execute the instructions to cause the apparatus to transmit the measurement as a CSI measurement considering the signal from the second UE.

18. The apparatus of claim 16, wherein the configuration indicates a signal strength threshold, and wherein the one or more processors are, individually or in combination, configured to execute the instructions to cause the apparatus to transmit the measurement as an indication of whether the measurement achieves the signal strength threshold.

19. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
transmit, to one or more user equipment (UEs), a time division duplexing (TDD) format configuration indicating at least a portion of multiple time divisions as being configured for downlink data communications from the apparatus; and
transmit, to the one or more UEs, an indication scheduling resources for transmitting, by a first UE and in a subset of at least the portion of the multiple time divisions, a signal to enable sensing by the first UE.

20. The apparatus of claim 19, wherein the one or more processors are, individually or in combination, configured to execute the instructions to cause the apparatus to receive, from a second UE, a measurement of a reference signal, wherein transmitting the indication is based on the measurement.

21. The apparatus of claim 19, wherein the one or more processors are, individually or in combination, configured to execute the instructions to cause the apparatus to transmit, to the one or more UEs, a reference signal configuration scheduling reference signal resources for transmitting, by the first UE and in the subset of at least the portion of the multiple time divisions or in a subset of a second portion of the multiple time divisions configured for uplink data communications from the first UE or flexible, the reference signal.

22. The apparatus of claim 19, wherein the resources are orthogonal in frequency to other resources in at least the portion of the multiple time divisions scheduled for the downlink data communications.

23. The apparatus of claim 19, wherein the one or more processors are, individually or in combination, configured to execute the instructions to cause the apparatus to puncture downlink data symbols or resource elements in at least the portion of the multiple time divisions that overlap the resources for the signal.

24. The apparatus of claim 23, wherein the one or more processors are, individually or in combination, configured to execute the instructions to cause the apparatus to transmit, to a second UE, an indication of the punctured downlink data symbols or resource elements.

25. The apparatus of claim 19, wherein the one or more processors are, individually or in combination, configured to execute the instructions to cause the apparatus to rate match around downlink data symbols or resource elements in at least the portion of the multiple time divisions that overlap the resources for the signal.

26. The apparatus of claim 19, wherein the resources are moved from uniformly spaced resources that are initially configured for transmitting, by the first UE, the signal to enable sensing.

27. The apparatus of claim 26, wherein the one or more processors are, individually or in combination, configured to execute the instructions to cause the apparatus to transmit, to the first UE, a semi-static configuration indicating the uniformly spaced resources.

28. The apparatus of claim 27, wherein the one or more processors are, individually or in combination, configured to execute the instructions to cause the apparatus to transmit, to the first UE, a dynamic configuration indicating moving of the uniformly spaced resources.

29. The apparatus of claim 26, wherein the one or more processors are, individually or in combination, configured to execute the instructions to cause the apparatus to receive, from the first UE, a UE capability indicating support for non-uniform sensing, wherein the one or more processors are, individually or in combination, configured to execute the instructions to cause the apparatus to move the resources from the uniformly spaced resources based at least in part on the UE capability.

30. A method for wireless communications at a user equipment (UE), comprising:
receiving, from a network entity, a time division duplexing (TDD) format configuration indicating at least a portion of multiple time divisions as being configured for downlink data communications from the network entity; and
transmitting, in a subset of at least the portion of the multiple time divisions, a signal to enable sensing by the UE.
